(19) United States
(12) Patent Application Publication
(10) Pub. No.: US 2008/0174420 A1
(43) Pub. Date: Jul. 24, 2008

(54) PORTABLE ELECTRONIC DEVICE WITH A FUNCTION OF DETECTING HOUSING SEPARATION

(76) Inventors: Ying-Chun Hsu, Taipei City (TW); Jui-Ching Yang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/852,327

(22) Filed: Sep. 10, 2007

(30) Foreign Application Priority Data
Jan. 18, 2007 (TW) 096101906

(51) Int. Cl. G08B 21/00

(52) U.S. Cl. 340/539.11

(57) ABSTRACT

A portable electronic device includes a first housing, an elastic structure connected to the first housing, a conductive material layer disposed on a side of the elastic structure, and a second housing. The first housing is connected to the second housing in a detachable manner. The portable electronic device includes a circuit board disposed on a side of the second housing. A metal pad is disposed on the circuit board and located in a position corresponding to the conductive material layer. The conductive material layer contacts with the metal pad when the first housing is connected to the second housing. The conductive material layer separates from the metal pad when the first housing separates from the second housing. The portable electronic device includes a detecting module installed inside the second housing and electrically connected to the circuit board for detecting whether the conductive material layer contacts with the metal pad.

### BACKGROUND OF THE INVENTION

1. Field of the Invention

The present invention relates to a portable electronic device, and more particularly, to a portable electronic device with a function of detecting housing separation.

2. Description of the Prior Art

In highly developed information communication systems in the modern information society, electronic devices are widely utilized in every area. For instance, the utilization of a convenient and lightweight mobile phone, a personal digital assistant (PDA), and an industrial PDA have become a way of communication in our daily life. In regard to the impact protection or drop protection of portable electronic products, most drop test standards follow real usage scenarios for the products to be tested. However it is not always easy to predict all usage patterns of products by consumers. The drop might cause damage of the portable electronic products without an effective impact-proof mechanism. For example, it is easy to damage the hard disk because of crashing a magnetic head of the hard disk, such as falling down ground, when the hard disk is reading or writing data so that the stored data get lost. Besides, a battery cover might separates from a main body due to impact of the drop so that a battery falls off the main body causing power failure of the system.

Please refer to FIG. 1, FIG. 2, and FIG. 3. FIG. 1 is a functional block diagram of a portable electronic device 10 in the prior art. FIG. 2 is a schematic drawing of the portable electronic device 10 in the prior art. FIG. 3 is a sectional view along 2-2′ in FIG. 2 of the portable electronic device 10 in the prior art. The portable electronic device 10 can be a personal digital assistant (PDA), an industrial PDA, a mobile phone, a notebook computer, and so on. The portable electronic device 10 includes a first housing 12, and a second housing 14 for covering inner components with the first housing 12 together. The first housing 12 is connected to the second housing 14 in a detachable manner. The first housing 12 and the second housing 14 can be made of plastic material. Please refer to FIG. 1 to FIG. 4. FIG. 4 is a schematic drawing of the first housing 12 in the prior art. The first housing 12 includes a pillar 16 made of plastic material. The portable electronic device 10 further includes a switch 18 installed on a side of the second housing 14 and located on a position corresponding to the pillar 16 of the first housing 12. When the first housing 12 connects with the second housing 14, the pillar 16 presses down the switch 18. When the first housing 12 separates from the second housing 14, the pillar 16 separates from the switch 18. The portable electronic device 10 further includes a buffer memory 19 installed inside the second housing 14 for storing data temporarily, a storage module 20 installed inside the second housing 14 for storing data, and a power supply module 22 for providing electricity to the portable electronic device 10. The power supply module 22 can be a battery. The first housing 12 and the second housing 14 covers the power supply module 22 together. The portable electronic device 10 further includes a control module 24 installed inside the second housing 14 and electrically connected to the switch 18, the storage module 20, the power supply module 22 for controlling the portable electronic device 10 according to a switch signal transmitted from the switch 18. The portable electronic device 10 further includes a warning interface 26. The control module 24 controls the warning interface 26 to present a warning message according to the switch signal transmitted from the switch 18. The warning interface 26 can be a display module, and the control module 24 controls the display module to display the warning message according to the switch signal transmitted from the switch 18 so as to inform a user of separation of the first housing 12 and the second housing 14. The warning interface 26 can be a speaker, and the control module 24 controls the speaker to sound the warning message according to the switch signal transmitted from the switch 18 so as to inform the user of separation of the first housing 12 and the second housing 14.

Please refer to FIG. 5 and FIG. 6. FIG. 5 is an enlarged diagram of the pillar 16 and the switch 18 when the first housing 12 and the second housing 14 are combined in the prior art. FIG. 6 is an enlarged diagram of the pillar 16 and the switch 18 when the first housing 12 and the second housing 14 are separated in the prior art. When the first housing 12 and the second housing 14 are combined, the pillar 16 of the first housing 12 presses the switch 18 on the second housing 14. When the first housing 12 and the second housing 14 are separated due to disassembling the first housing 12, the condition that the pillar 16 of the first housing 12 presses the switch 18 on the second housing 14 switches to the condition that the pillar 16 of the first housing 12 separates from the switch 18 on the second housing 14. The switch 18 outputs a corresponding switch signal to the control module 24. After the control module 24 receives the switch signal, the control module 24 controls the portable electronic device 10 to execute a corresponding operation. For example, the control module 24 controls the warning interface 26 to present the warning message so as to inform the user of separation of the first housing 12 and the second housing 14. The control module 24 can store system data in the buffer memory 19, such as a cache memory or RAM, to the storage module 20 for preventing data loss due to power failure of the system caused by departure of the power supply module 22. If the storage module 20 is a hard disk, the control module 24 can control the hard disk to park a magnetic head thereof for preventing damage of the magnetic head and magnetic sections due to power failure of the system caused by departure of the power supply module 22. After the control module 24 saves the data in the buffer memory 19 to the storage module 20 when knowing the first housing 12 and second housing 14 are separated, the control module 24 can control the power supply module 22 to stop supplying electricity to the portable electronic device 10. The control module 24 can turn off the portable electronic device 10 for preventing a system crash due to power failure of the system caused by departure of the power supply module 22.

However the pillar 16 of the first housing 12 is always a solid plastic component. When the portable electronic device 10 falls down and crashes the ground, the pillar 16 might break and the switch 18 might be damaged. Furthermore, even when the first housing 12 and the second housing 14 are not separated but the portable electronic device 10 is vibrated, the pillar 16 might separate from the switch 18 causing erroneous judgment of separation of the first housing 12 and the second housing 14.

### SUMMARY OF THE INVENTION

It is therefore a primary objective of the claimed invention to provide a portable electronic device with a function of detecting housing separation for solving the above-mentioned problem.

According to the claimed invention, a portable electronic device includes a first housing, an elastic structure connected to the first housing, a conductive material layer disposed on a side of the elastic structure, and a second housing. The first housing is connected to the second housing in a detachable manner. The portable electronic device further includes a circuit board disposed on a side of the second housing. A metal pad is disposed on the circuit board and located in a position corresponding to the conductive material layer. The conductive material layer contacts with the metal pad when the first housing is connected to the second housing. The conductive material layer separates from the metal pad when the first housing separates from the second housing. The portable electronic device further includes a detecting module installed inside the second housing and electrically connected to the circuit board for detecting whether the conductive material layer contacts with the metal pad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a portable electronic device in the prior art.

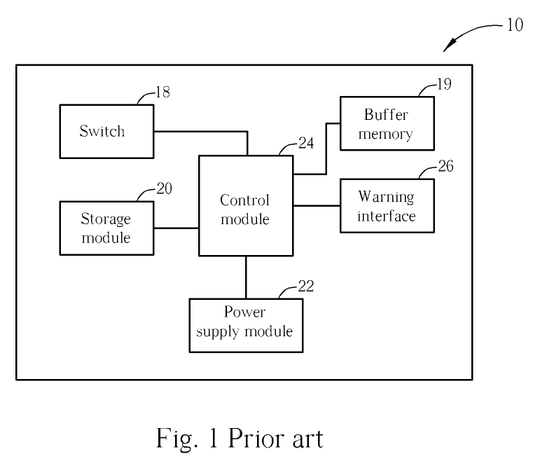

FIG. 2 is a schematic drawing of the portable electronic device in the prior art.

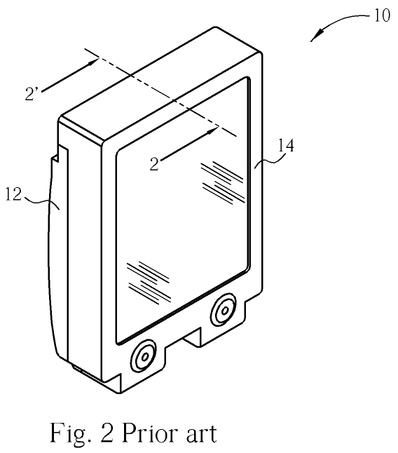

FIG. 3 is a sectional view along 2-2′ in FIG. 2 of the portable electronic device in the prior art.

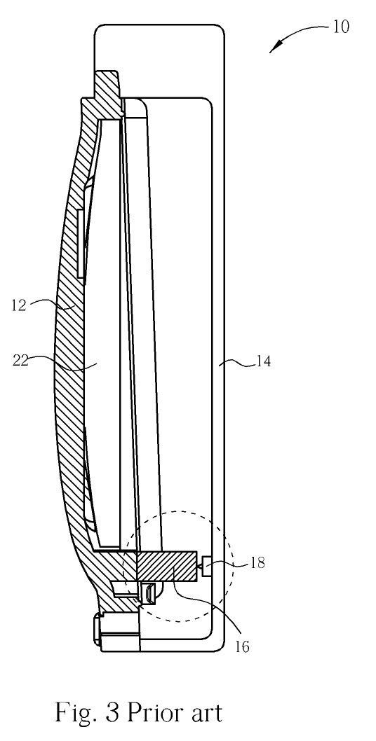

FIG. 4 is a schematic drawing of a first housing in the prior art.

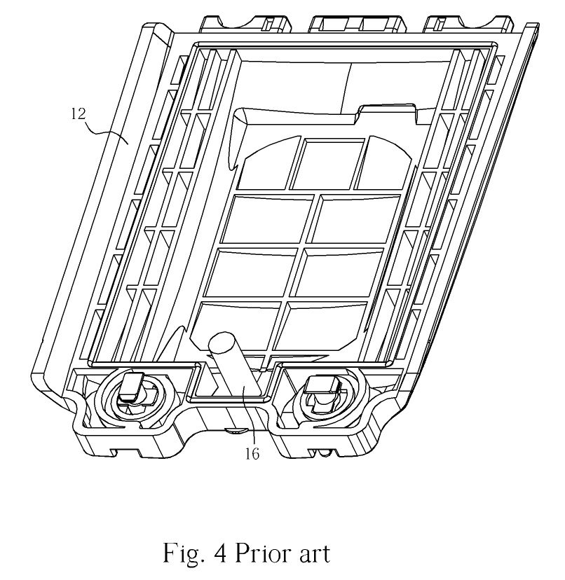

FIG. 5 is an enlarged diagram of a pillar and a switch when the first housing and a second housing are combined in the prior art.

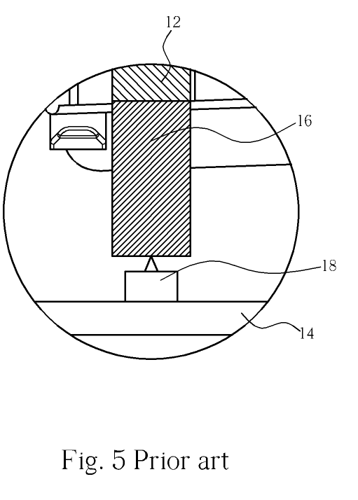

FIG. 6 is an enlarged diagram of the pillar and the switch when the first housing and the second housing are separated in the prior art.

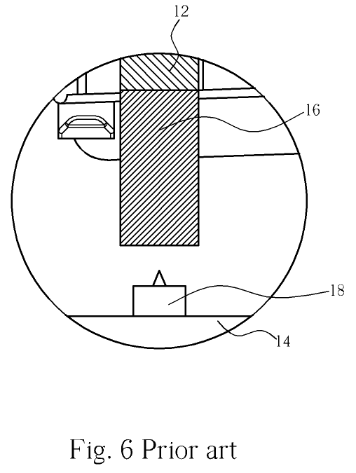

FIG. 7 is a functional block diagram of a portable electronic device of the present invention.

FIG. 8 is a schematic drawing of the portable electronic device of the present invention.

FIG. 9 is a sectional view along 8-8′ in FIG. 8 of the portable electronic device of the present invention.

FIG. 10 is a schematic drawing of a first housing of the present invention.

FIG. 11 is a diagram of a metal pad of the present invention.

FIG. 12 is an enlarged diagram of an elastic structure and a circuit board when a first housing and a second housing are combined of the present invention.

FIG. 13 is an enlarged diagram of the elastic structure and the circuit board when the first housing and the second housing are separated of the present invention.

FIG. 14 is a diagram of the deformed elastic structure contacting with the circuit board of the present invention.

### DETAILED DESCRIPTION

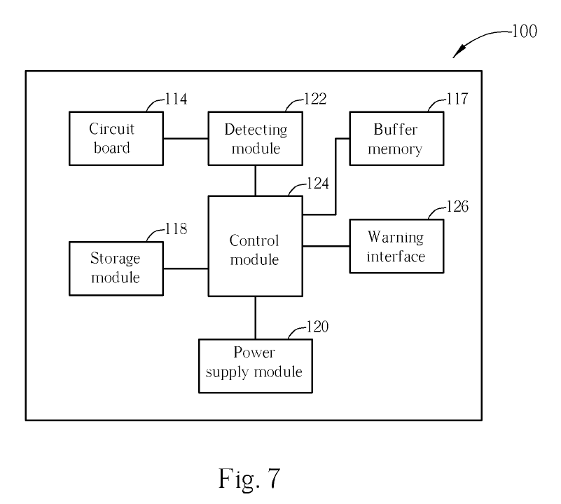

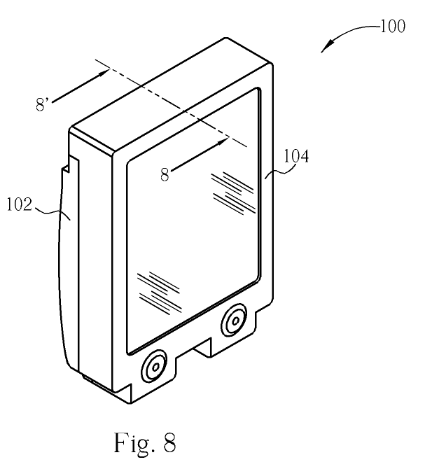

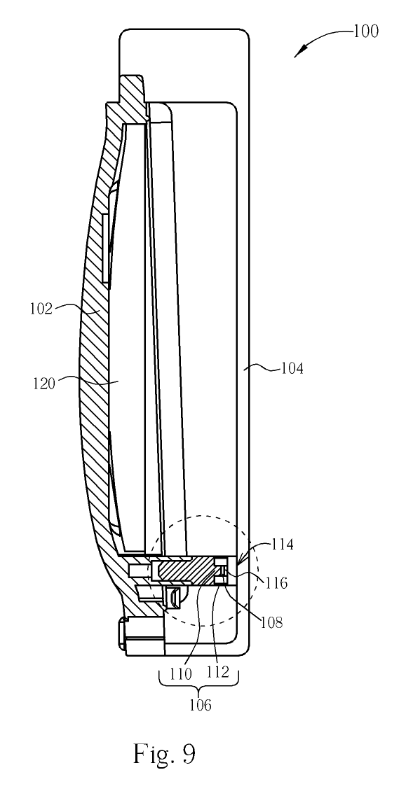

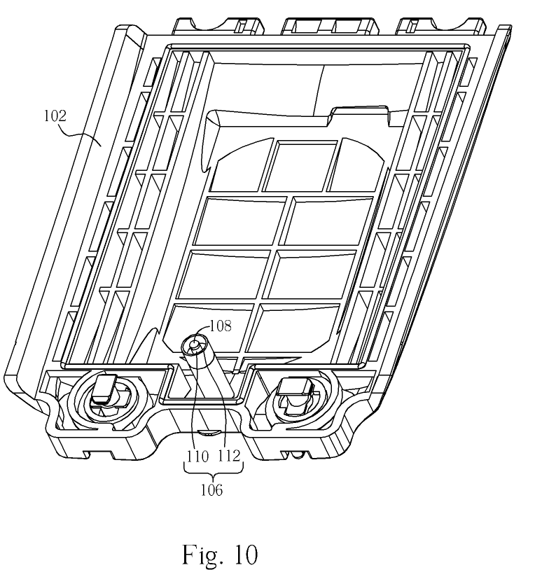

Please refer to FIG. 7, FIG. 8, and FIG. 9. FIG. 7 is a functional block diagram of a portable electronic device 100 of the present invention. FIG. 8 is a schematic drawing of the portable electronic device 100 of the present invention. FIG. 9 is a sectional view along 8-8′ in FIG. 8 of the portable electronic device 100 of the present invention. The portable electronic device 100 can be a personal digital assistant (PDA), an industrial PDA, a mobile phone, a notebook computer, and so on. The portable electronic device 100 includes a first housing 102, and a second housing 104 for covering inner components with the first housing 102 together. The first housing 102 is connected to the second housing 104 in a detachable manner. The first housing 102 and the second housing 104 can be made of plastic material. Please refer to FIG. 7 to FIG. 10. FIG. 10 is a schematic drawing of the first housing 102 of the present invention. The portable electronic device 100 further includes an elastic structure 106 connected to the first housing 102, and a conductive material layer 108 disposed on a side of the elastic structure 106. The elastic structure 106 can be made of rubber material, silica gel material, and so on. The conductive material layer 108 can be made of conductive material, such as a conductive carbon granule layer, a conductive gasket layer, an electroplating metal layer, or a conductive paint layer. The elastic structure 106 includes a pillar 110 which can be a cylinder and is connected to the conductive material layer 108, and a lateral wall 112 disposed around the pillar 110 for protecting the conductive material layer 108, such as protecting carbon granules of the conductive material layer 108 from wear. The portable electronic device 100 further includes a circuit board 114 disposed on a side of the second housing 104. A metal pad 116 is disposed on the circuit board 114 and located in a position corresponding to the conductive material layer 108. The conductive material layer 108 contacts with the metal pad 116 when the first housing 102 is connected to the second housing 104. The conductive material layer 108 separates from the metal pad 116 when the first housing 102 separates from the second housing 104. The portable electronic device 100 further includes a buffer memory 117 installed inside the second housing 104 for storing data temporarily, a storage module 118 installed inside the second housing 104 for storing data, and a power supply module 120 for providing electricity to the portable electronic device 100. The power supply module 120 can be a battery. The first housing 102 and the second housing 104 covers the power supply module 120 together. The portable electronic device 100 further includes a detecting module 122 installed inside the second housing 104 and electrically connected to the circuit board 114 for detecting whether the conductive material layer 108 contacts with the metal pad 116, and a control module 124 installed inside the second housing 104 and electrically connected to the detecting module 122, the storage module 118, and the power supply module 120 for controlling operation of the portable electronic device 100 according to a detecting result of the detecting module 122. The portable electronic device 100 further includes a warning interface 126. The control module 124 can control the warning interface 126 according to the detecting result of the detecting module 122. The warning interface 126 can be a display module, and the control module 124 controls the display module to display the warning message according to the detecting result of the detecting module 122 so as to inform a user of separation of the first housing 102 and the second housing 104. The warning interface 126 can be a speaker, and the control module 124 controls the speaker to sound the warning message according to the detecting result of the detecting module 122 so as to inform the user of separation of the first housing 102 and the second housing 104.

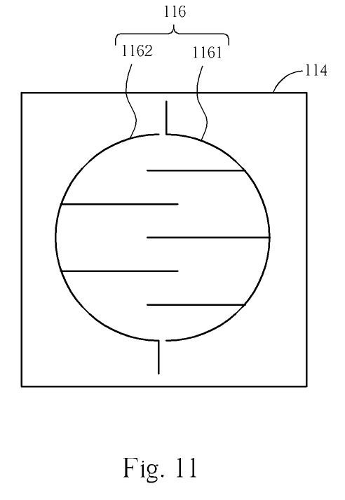

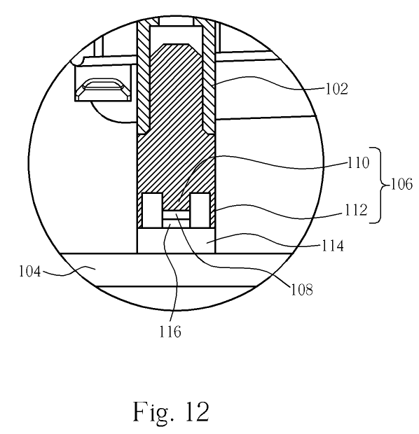

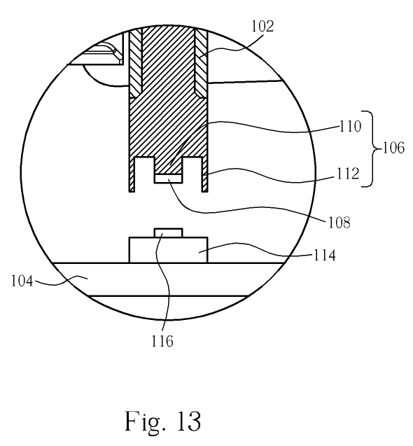

Please refer to FIG. 11, FIG. 12, and FIG. 13. FIG. 11 is a diagram of the metal pad 116 of the present invention. FIG. 12 is an enlarged diagram of the elastic structure 106 and the circuit board 114 when the first housing 102 and the second housing 104 are combined of the present invention. FIG. 13 is an enlarged diagram of the elastic structure 106 and the circuit board 114 when the first housing 12 and the second housing 14 are separated of the present invention. The metal pad 116 includes a first metal section 1161 and a second metal section 1162. The first metal section 1161 and the second metal section 1162 can be made of exposed cooper. When the first housing 102 and the second housing 104 are combined, the conductive material layer 108 disposed on the side of the elastic structure 106 connected to the first housing 102 presses the metal pad 116 so as to connect the first metal section 1161 and the second metal section 1162 electrically. When the first housing 102 and the second housing 104 are separated due to disassembling the first housing 102, the condition that the conductive material layer 108 disposed on the side of the elastic structure 106 connected to the first housing 102 presses the metal pad 116 switches to the condition that the conductive material layer 108 separates from the metal pad 116 so that the first metal section 1161 and the second metal section 1162 can not be connected electrically. When the detecting module 122 detects the condition that the first metal section 1161 and the second metal section 1162 are connected electrically switches to the condition that the first metal section 1161 and the second metal section 1162 are not connected electrically, that is, the condition that the conductive material layer 108 presses the metal pad 116 switches to the condition that the conductive material layer 108 separates from the metal pad 116, the detecting module 122 outputs a corresponding signal to the control module 124. The control module 124 controls the portable electronic device 100 to execute a corresponding operation after receiving the corresponding signal. For example, the control module 124 can control the warning interface 126 to present the warning message so as to inform the user of separation of the first housing 102 and the second housing 104. The control module 124 can store system data in the buffer memory 117, such as a cache memory or RAM, to the storage module 118 for preventing data loss due to power failure of the system caused by departure of the power supply module 120. If the storage module 118 is a hard disk, the control module 124 can control the hard disk to park a magnetic head thereof for preventing damage of the magnetic head and magnetic sections due to power failure of the system caused by departure of the power supply module 120. After the control module 124 saves the data in the buffer memory 117 to the storage module 118 when knowing the first housing 102 and second housing 104 are separated, the control module 124 can control the power supply module 120 to stop supplying electricity to the portable electronic device 100. The control module 124 can turn off the portable electronic device 100 for preventing a system crash due to power failure of the system caused by departure of the power supply module 120.

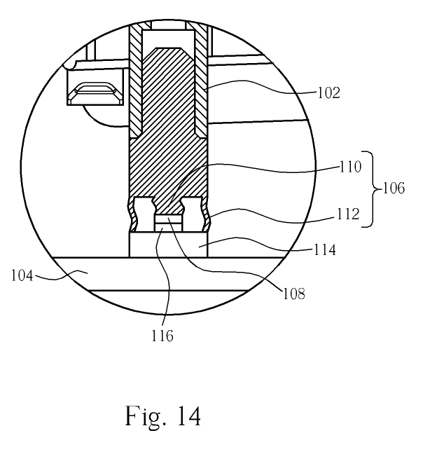

Please refer to FIG. 14. FIG. 14 is a diagram of the deformed elastic structure 106 contacting with the circuit board 114 of the present invention. When the first housing 102 and the second housing 104 are combined and the elastic structure 106 is deformed, the conductive material layer 108 disposed on the elastic structure 106 can press the metal pad 116 so that the first metal section 1161 and the second metal section 1162 can be connected electrically. The conductive material layer 108 can keep pressing the metal pad 116 due to the predeformation of the elastic structure 106 even when the portable electronic device 100 is vibrated so that there is a relative movement between the first housing 102 and the second housing 104 and the first housing 102 is not taken apart from the second housing 104. It can avoid erroneous judgment of separation of the first housing 102 and the second housing 104. Furthermore, when the portable electronic device 100 falls down and crashes the ground, the flexible elastic structure 106 can not break easily. The cost of the elastic structure 106, the conductive material layer 108, and the circuit board 14 is much less than the cost of the conventional switch.

In contrast to the conventional portable electronic device, the portable electronic device of the present invention utilizes the flexible elastic structure and the conductive material layer for conducting the metal pad on the circuit board so as to judge the separation of the housings. Because the conductive material layer can keep pressing the metal pad due to the predeformation of the elastic structure, it can avoid erroneous judgment of separation of the housings. Furthermore, when the portable electronic device falls down and crashes the ground, the flexible elastic structure can not break easily. The cost of the mechanism of the present invention is much less than the cost of the conventional switch.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a first housing;
an elastic structure connected to the first housing;
a conductive material layer disposed on a side of the elastic structure;
a second housing, the first housing being connected to the second housing in a detachable manner;
a circuit board disposed on a side of the second housing, a metal pad being disposed on the circuit board and located in a position corresponding to the conductive material layer, the conductive material layer contacting with the metal pad when the first housing is connected to the second housing, and the conductive material layer separating from the metal pad when the first housing separates from the second housing; and
a detecting module installed inside the second housing and electrically connected to the circuit board for detecting whether the conductive material layer contacts with the metal pad.

2. The portable electronic device of claim 1 wherein the elastic structure comprises:
a pillar connected to the conductive material layer; and
a lateral wall disposed around the pillar for protecting the conductive material layer.

3. The portable electronic device of claim 1 wherein the pillar is a cylinder.

4. The portable electronic device of claim 1 wherein the elastic structure is made of rubber material.

5. The portable electronic device of claim 1 wherein the elastic structure is made of silica gel material.

6. The portable electronic device of claim 1 wherein the conductive material layer is a conductive carbon granule layer.

7. The portable electronic device of claim 1 wherein the conductive material layer is a conductive gasket layer.

8. The portable electronic device of claim 1 wherein the conductive material layer is an electroplating metal layer.

9. The portable electronic device of claim 1 wherein the conductive material layer is a conductive paint layer.

10. The portable electronic device of claim 1 further comprising a power supply module wherein the first housing and the second housing covers the power supply module jointly.

11. The portable electronic device of claim 10 wherein the power supply module is a battery.

12. The portable electronic device of claim 10 further comprising a control module installed inside the second housing and electrically connected to the detecting module for controlling the power supply module to stop supplying electricity to the portable electronic device when detecting the conductive material layer contacts with the metal pad by the detecting module switches to detecting the conductive material layer separates from the metal pad by the detecting module.

13. The portable electronic device of claim 1 further comprising a control module installed inside the second housing and electrically connected to the detecting module for controlling the portable electronic device according to a detecting result of the detecting module.

14. The portable electronic device of claim 13 further comprising a buffer memory installed inside the second housing, and a storage module installed inside the second housing wherein the control module stores system data in the buffer memory to the storage module when detecting the conductive material layer contacts with the metal pad by the detecting module switches to detecting the conductive material layer separates from the metal pad by the detecting module.

15. The portable electronic device of claim 14 wherein the storage module is a hard disk and the control module controls the hard disk to park a magnetic head thereof when detecting the conductive material layer contacts with the metal pad by the detecting module switches to detecting the conductive material layer separates from the metal pad by the detecting module.

16. The portable electronic device of claim 13 wherein the control module turns off the portable electronic device when detecting the conductive material layer contacts with the metal pad by the detecting module switches to detecting the conductive material layer separates from the metal pad by the detecting module.

17. The portable electronic device of claim 13 further comprising a warning interface wherein the control module controls the warning interface to present a warning message when detecting the conductive material layer contacts with the metal pad by the detecting module switches to detecting the conductive material layer separates from the metal pad by the detecting module.

18. The portable electronic device of claim 17 wherein the warning interface is a display module.

19. The portable electronic device of claim 17 wherein the warning interface is a speaker.

20. The portable electronic device of claim 13 wherein the detecting module detects whether a circuit of the metal pad is closed so as to output a detecting signal to the control module.

21. The portable electronic device of claim 1 being a personal digital assistant (PDA).

22. The portable electronic device of claim 1 being a mobile phone.

23. The portable electronic device of claim 1 being a notebook computer.
